(19) United States
(12) Patent Application Publication
(10) Pub. No.: US 2021/0051197 A1
(43) Pub. Date: Feb. 18, 2021

(54) SYSTEM AND METHOD FOR REMOTE TECHNICAL SUPPORT IN AN INTERNET OF THINGS (IOT) ENVIRONMENT

(71) Applicant: Siemens Logistics LLC, DFW Airport, TX (US)

(72) Inventor: Michael D. Carpenter, Arlington, TX (US)

(21) Appl. No.: 16/541,887

(22) Filed: Aug. 15, 2019

(51) Int. Cl. H04L 29/08; H04W 12/00; G06N 5/04; G06K 7/14; H04W 4/80; H04L 12/24

(52) U.S. Cl. CPC H04L 67/12; H04W 12/00407; G06N 5/045; H04L 41/22; G06K 7/1413; H04W 4/80; H04L 41/069; G06K 7/1417

(57) ABSTRACT

A system for remote technical support includes a user interface device with a memory storing a computer program with executable instructions, an identification tag of a technical system, and a secure communication link interfacing with the user interface device and adapted to transmit data, wherein the computer program includes instructions to read the identification tag, to establish communication to the technical system via the secure communication link, and to obtain technical data of the technical system via the secure communication link, wherein obtained technical data are further processed by an application for remote technical support.

### BACKGROUND

### 1. Field

Aspects of the present disclosure generally relate to systems and methods for remote technical support in an Internet of Things (IoT) environment, for example in the technical field of mail and parcel processing techniques.

### 2. Description of the Related Art

With an increasing level of technology common to products in most markets, potential exists to significantly improve user experience by leveraging dedicated applications, which in many cases correspond with utilization of high-speed network interconnectivity and transfer of customer data. Various technology trends affecting this transformation are sometimes referred to by an umbrella term: Internet of Things (IoT). Simply described, the IoT is the concept of connecting a physical device to the Internet. Embedded with electronics, Internet connectivity and other forms of hardware, such as sensors, the device can communicate and interact with other connected devices and can be remotely monitored and controlled.

Remote technical support, typically served by verbal telephone communications, may be simplified by the elimination of a need to verbally transfer information about a customer, a product and circumstances that have necessitated the need for remote technical support. Electronic transfer of background information may reduce the need for verbal dialog, improve accuracy of provided information and improve effectiveness of technical support.

Customer concerns regarding data breaches, viruses, worms, and other hacking of their critical operational systems has traditionally led them to refuse to connect these systems to the Internet, so that the full range of IoT optimization has been impossible to achieve. Without enablement of technological improvements related to IoT and other technologies, customer maintenance is forced to be conducted in obsolescent approaches, such as help desk, product documents (manuals etc.), and ad hoc troubleshooting approaches.

### SUMMARY

A first aspect of the present disclosure provides a system for remote technical support comprising: a user interface device comprising a memory device storing a computer program with executable instructions, an identification tag of a technical system, and a secure communication link interfacing with the user interface device and adapted to transmit data, wherein the computer program comprises instructions to read the identification tag, to establish communication to the technical system via the secure communication link, and to obtain technical data of the technical system via the secure communication link, wherein obtained technical data are further processed by an application for remote technical support.

A second aspect of the present disclosure provides a method for remote technical support comprising: reading, by a user interface device, an identification tag of a technical system, establishing communication by the user interface device to the technical system via a secure communication link, obtaining technical data of the technical system via the secure communication link, wherein obtained technical data are further processed by an application for remote technical support.

### BRIEF DESCRIPTION OF THE DRAWINGS

FIG. 1 depicts a first schematic diagram of a system for remote technical support in accordance with an exemplary embodiment of the present disclosure.

FIG. 2 depicts an example identification tag of a mail or parcel processing apparatus in accordance with an exemplary embodiment of the present disclosure.

FIG. 3 depicts a second schematic diagram of a system for remote technical support in accordance with an exemplary embodiment of the present disclosure.

FIG. 4 depicts a third schematic diagram of a system for remote technical support in accordance with an exemplary embodiment of the present disclosure.

FIG. 5 depicts a flow chart of a method for remote technical support in accordance with an exemplary embodiment of the present disclosure.

### DETAILED DESCRIPTION

To facilitate an understanding of embodiments, principles, and features of the present disclosure, they are explained hereinafter with reference to implementation in illustrative embodiments. In particular, they are described in the context of being systems and methods for remote technical support in an Internet of Things (IoT) environment, for example within a technical field of mail and parcel processing techniques. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

Various disclosed embodiments include systems and methods for remote technical support within the IoT environment, for example within the technical field of mail and parcel processing. Parcel delivery services, such as the United Parcel Service (UPS) or the United States Postal Service (USPS), deal with everything that occurs for every item that they deliver between the origination and the destination across the delivery logistic. Multi-step processes typically involve repeating a sequence of unloading, sorting, and loading which is accomplished by an interconnected series of mixed manual and automatic equipment. Automatic equipment may include for example unloading apparatuses, diverter systems, singulator systems, conveyor systems etc.

The IoT and associated technologies can improve the user experience and capabilities of maintenance personnel in many fields. For example, configuration and logging information, including error codes and other relevant information, may be transferred to remote systems or applications capable of correlating the data received with potential solutions, based on data accumulated over time from many similar systems.

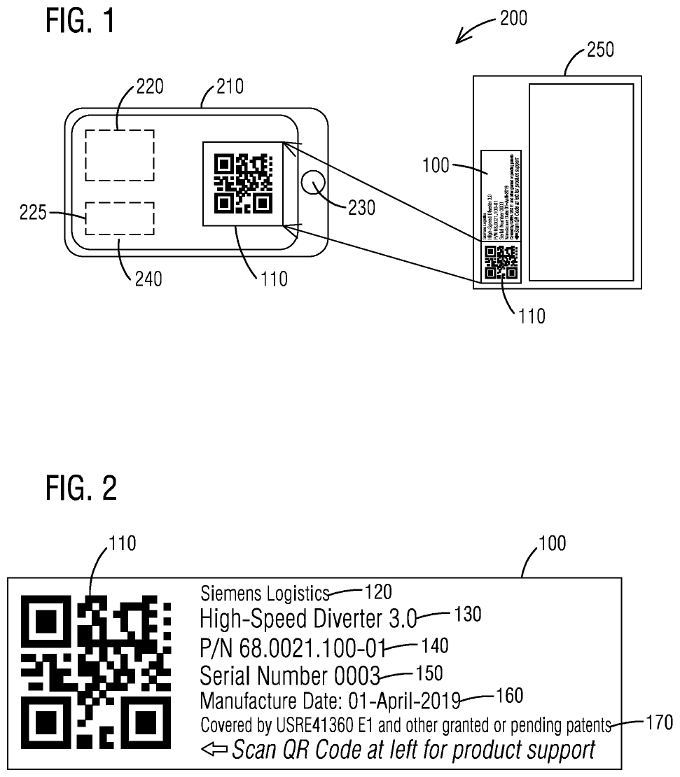

FIG. 1 depicts a first schematic diagram of a system 200 for remote technical support in an IoT environment in accordance with an exemplary embodiment of the present disclosure. The system 200 is herein also referred to as remote support system 200.

The remote support system 200 comprises a user interface device 210 and technical system or component 250. The user interface device 210 is a mobile device and/or hand-held device comprising a memory 220 storing a computer program with executable instructions, such as program modules, being executed by a computer system, such as at least one processor 225. Generally, program modules include routines, programs, programming, objects, components, data, data structures, and the like that perform particular tasks or implement particular abstract data types. The memory 220 of the user interface device 210 is configured as non-volatile, removable, and/or non-removable medium implemented in many methods or technologies for storage of information such as computer-readable instructions, data, data structures, program modules, programs, programming, or routines.

The user interface device 210 can be for example a touch screen device, a tablet, smart phone, personal computer, laptop computer, or similar multi-function device, with storage and wireless capabilities. Further, the user interface device 210 comprises a digital imaging device 230, such as for example a digital camera, for capturing images and data, and a display or screen 240 for displaying data, images, information etc.

The technical system or component 250 is only shown schematically and can be many different technical systems. In an example, the technical system 250 is a mail or parcel processing system, such as an unloader, diverter, conveyor, singulator, loader etc.

In an embodiment of the present disclosure, the technical system 250 comprises an identification tag 100 which can be placed on any suitable surface or section of the technical system 250. As illustrated in FIG. 1, the identification tag 100, specifically a code, such as a Quick Response (QR) code 110, is captured by the user interface device 210 via digital camera 230 and read/interpreted by a corresponding application for processing QR codes stored in the user interface device 210. The identification tag 100 will be described in more detail with reference to FIG. 2.

FIG. 2 depicts an example identification tag 100 of a mail or parcel processing system or apparatus in accordance with an exemplary embodiment of the present disclosure. The identification tag 100 relates to a technical system, specifically a mail or parcel processing system, such as for example an unloading system, diverter system, conveyor system etc. The identification tag 100 can be attached or incorporated near a human machine interface (HMI)-device, main panel, operator panel or terminal computer of the mail or parcel processing system.

The identification tag 100 can be a physical element which can be attached to the technical system. For example, the identification tag 100 can be a sticker or similar type of tag or label made of paper and/or plastics which can be attached to an outside, for example housing or enclosure, of the technical system. In another example, the identification tag 100 may be a permanent part of the technical system, for example printed directly onto the technical system, e.g. main panel. Alternatively, the identification tag 100 may be configured as software tag and displayed on a screen or display of the technical system if the technical system comprises a screen or display. For example, a main panel or HMI device with a display may display the identification tag 100 upon a user's request.

The identification tag 100 comprises data and/or information which uniquely describe and identify the technical system. The identification tag 100 comprises a Quick Response (QR) code 110. Instead of QR code 110, the tag 100 may comprise a barcode or other machine-readable code. Barcode and QR code, which is a matrix or two-dimensional barcode, are machine-readable optical labels that contain information about a specific item, for example the item or system the code is attached to.

The identification tag 100 comprises information such as for example manufacturer information 120 (‘Siemens Logistics’), name of technical system 130 (‘High-Speed Diverter 3.0’), part number (P/N) 140 (‘P/N 68.0021.100-01’), serial number 150 (‘Serial Number 0003’), Manufacture date 160 (‘01-Aril-2019’), and additional various information 170, such as for example ‘Covered by USRE41360 E1 and other granted or pending patents’ and instructions such as for example ‘Scan QR code at left for product support’.

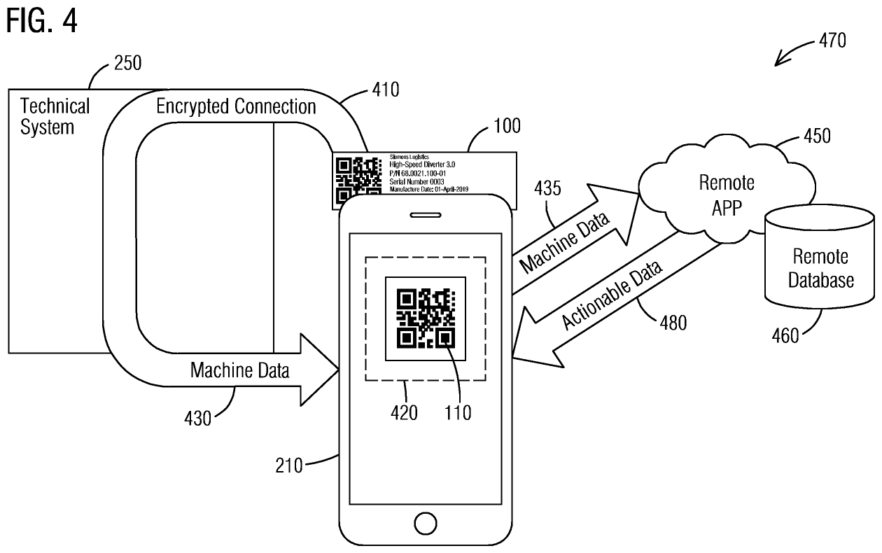

All or only some of the information 120, 130, 140, 150, 160, 170 provided on the identification tag 100 is embedded in the QR code 110. For example, name of technical system 130, part number 140 and serial number 150 may be embedded in the QR code, wherein the additional information 170 may not be embedded in the QR code 110. Further information embedded in the QR code 110 can be a web address, for example of the manufacturer, and/or information for establishing a secure wireless connection, for example a network address such as an IP address or a MAC address, including secure sign-on information. Thus, a secure wireless connection may be established to a user interface device, see for example FIG. 4.

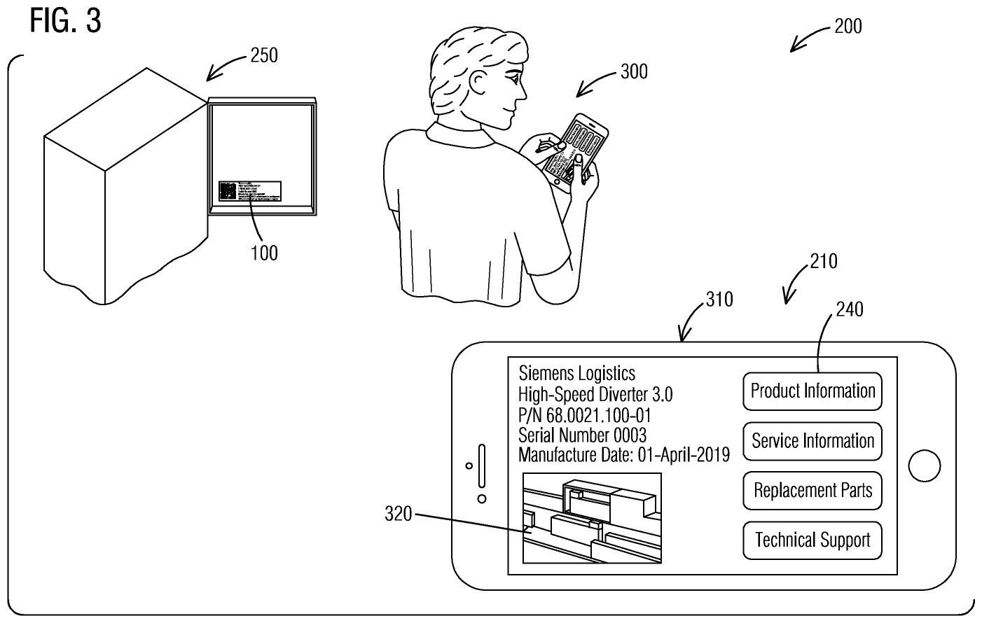

FIG. 3 depicts a second schematic diagram of a system 200 for remote technical support in accordance with an exemplary embodiment of the present disclosure. After capturing and processing of the QR code 110 by the user interface device 210, the user interface device 210 may display certain information of the technical system 250, retrieved for example from a remote data reservoir.

For example, when a user 300 requires technical support for the product 250, the QR code 110 is scanned by a smartphone or other similar multifunction device 210. When the user 300 scans the QR code 110, a browser of the user interface device 210 is directed to a product support webpage and the device 210 loads the webpage from the internet using cellular or other wireless network. The webpage displays, on the display 240 of the device 210, product information 320, including name of the product, part number, serial number etc. Further, different categories 310 are provided including relevant information for the respective product, such as product information (access operational and technical manuals), service information (view maintenance videos), access to replacement part ordering, or connection to technical support. The user 300 now has the option to browse in the different categories 310, order replacement parts or contact technical support, for example by phone, email, text messaging etc.

FIG. 4 depicts a schematic diagram of a remote support system 400 for remote technical support in accordance with an exemplary embodiment of the present disclosure. The remote support system 400 provides an advanced solution within IoT environment for remote support and diagnostics.

In this exemplary scenario, the QR code 110 of the technical system 250 is scanned and processed accordingly by the user interface device 210, e.g. smartphone or tablet, within a dedicated mobile application 420 stored on the user interface device 210. The dedicated app 420 features many functionalities including for example a feature for scanning and processing the QR code 110 (or other machine-readable code), and/or a feature for establishing a secure wireless connection link 410 between the user interface device 210 and the technical system 250.

The QR code 110 can comprise a network address such as an IP address or a MAC address, including secure sign-on information, of the technical system 250. Thus, a secure wireless connection link 410 adapted to transmit data can be established between the technical system 250 and the user interface device 210. The communication link 410 provides secure, encrypted communication via a short-range wireless network protocol, such as for example Bluetooth, ZigBee, cellular network etc.

Via the encrypted communication link 410, technical data 430 of the system or product 250 can be transmitted to the user interface device 210, for example via or within the dedicated application 420. Technical data 430 of the system 250 can include system log files, current status, I/O states etc. It should be noted that data is only transferred from the system 250 to the user interface device 210, but no data is transferred from the user interface device 210 to the system 250. All of some of the obtained technical data 430 are further processed by an application, which can be the dedicated application 420 or a separate application, for remote technical support with respect to the technical system 250.

In an exemplary embodiment, the user interface device 210 interfaces wirelessly with a communication network 440, specifically the Internet, and thus comprises an air interface, e.g., Wi-Fi. The dedicated mobile application 420 is configured to connect to a remote cloud-based data reservoir 470. Via the wireless communication network 440, the dedicated application 420 may either sequentially or concurrently transfer some or all of the technical information or data 430 of the system 250 to a remote cloud-based application 450, thus providing an IoT environment. A cloud-based application (or cloud application or cloud app) refers to a software program where cloud-based components, e.g. cloud-based application 450 and cloud-based database 460, and local components, e.g. user interface device 210 and technical system 250, work together. It is relied on remote servers for processing logic that is accessed through a web browser of the user interface device 210 with continued Internet connection.

In another exemplary embodiment, instead of transferring some or all of the technical data to the cloud-based data reservoir 470 and/or application 450, the application for remote technical support, which can be the dedicated application 420, is configured to process some or all of the obtained technical data 430 on the user interface device 210. Further, the application may connect to the remote data reservoir 470 and/or remote application 450 and can be in communication with the remote data reservoir 470 and/or remote application 450 for processing of the technical data 430. This means that the technical data 430 are not necessarily transferred or transmitted to the remote (cloud-based) data reservoir or application 450, but certain routines, instructions or information for providing the remote technical support may be downloaded from the remote data reservoir 470 or application 450 to the user interface device 210. For example, while the application on the user interface device 210 is open and providing technical support to the user, the application may intermittently or continuously connect to the remote data reservoir 470 and/or remote application 450 without transferring technical date of the technical system 250 to the remote application 450.

In a further embodiment, the application, for example the dedicated application 420, or the remote cloud-based application 450 may feature machine learning functionality, whereby a history of interactions with various technical data 430 of various technical systems 250, refined by a “ground truth” of eventual outcomes for each product interaction, is used to provide specific, actionable data and technical support to the user 300 via user interface device 210. Thus, advanced troubleshooting through network accessible information, e.g., AI-based troubleshooting is provided. In machine learning, the term “ground truth” refers to for example proper objective (provable) data for specific scenarios, wherein the data and information may be provided or gathered for example by direct observation.

Various product data of multiple technical systems can be stored for example in a cloud-based remote database 460 or other not cloud-based remote database and analysed and utilized for remote technical support by the remote application 450 or the dedicated application 420 on the user interface device 210. For example, the remote application 450 or dedicated application on the user interface device 210 may provide suggested failure modes based on certain system log files of technical systems 250, wherein the remote application 450 or dedicated application 420 is further configured to provide actionable data and technical support to the user 300 for resolving or repairing the failure modes or errors of the respective technical system 250.

Replacement parts for the technical system 250 may also be ordered in this manner, e.g. via cloud application 450 or dedicated application 420. Further, in any case, maintenance activity continues to be orchestrated through the cloud application 450 or dedicated application 420, including for example scanning labels, e.g. identification tag 100, of parts removed and replaced, reminding the user 300 to return the system 250 to its original state, if a troubleshooting step, such as swapping a Field Replaceable Unit, does not affect resolution, and recording the step that affects resolution.

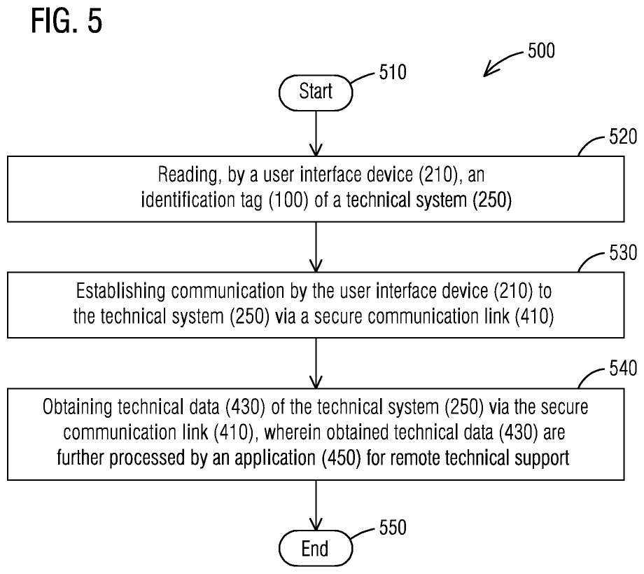

FIG. 5 depicts a flow chart of a method 500 for remote technical support in accordance with an exemplary embodiment of the present disclosure. The process or method 500 can be implemented by using any of the features, components, or devices discussed herein, or any combination of them. The method 500 is performed, for example, by remote support system 400 as disclosed herein, and under the control of its control system. While the method 500 is described as a series of acts that are performed in a sequence, it is to be understood that the method 500 may not be limited by the order of the sequence. For instance, unless stated otherwise, some acts may occur in a different order than what is described herein. In addition, in some cases, an act may occur concurrently with another act. Furthermore, in some instances, not all acts may be required to implement a methodology described herein.

The method 500 may start at 510 and may include an act 520 of reading, by a user interface device 210, an identification tag 100 of a technical system 250. The method 500 may also include act 530 of establishing communication by the user interface device 210 to the technical system 250 via a secure communication link 410. Further, the method 500 may include act 540 of obtaining technical data 430 of the technical system 250 via the secure communication link 410, wherein obtained technical data 430 are further processed by an application for remote technical support. At 550, the method 500 may end. It should be appreciated that the described method 500 may include additional acts and/or alternative acts corresponding to features described with respect to the systems 200, 400, see for example FIG. 3 and FIG. 4.

In an embodiment, the method 500 may further comprise providing, by the application, which can be a cloud-based application 450 or an application on the user interface device 210, such as dedicated application 420, suggested failure modes and associated solutions and/or maintenance manuals and/or videos. In another embodiment, the method 500 may further comprise establishing, by the application, contact to technical support. In another embodiment, the method 500 may further comprise ordering parts for the technical system via the application.

It should be appreciated that acts associated with the above-described methodologies, features, and functions (other than any described manual acts) may be carried out by one or more data processing systems via operation of at least one processor, for example the at least one processor 225 of user interface device 210. As used herein, a processor corresponds to any electronic device that is configured via hardware circuits, software, and/or firmware to process data. For example, processors described herein may correspond to one or more (or a combination) of a microprocessor, central processing unit (CPU) or any other integrated circuit (IC) or other type of circuit that is capable of processing data in a data processing system. As discussed, the at least one processor 225 is described or claimed as being configured to carry out a particular described/claimed process or function that may correspond to a CPU that executes computer/processor executable instructions stored in a memory in form of software and/or firmware to carry out such a described/claimed process or function. However, it should also be appreciated that such a processor may correspond to an IC that is hard wired with processing circuitry (e.g., an FPGA or ASIC IC) to carry out such a described/claimed process or function.

In addition, it should also be understood that a processor that is described or claimed as being configured to carry out a particular described/claimed process or function may correspond to the combination of the processor with the executable instructions (e.g., software/firmware apps) loaded/installed into a memory (volatile and/or non-volatile), which are currently being executed and/or are available to be executed by the processor to cause the processor to carry out the described/claimed process or function. Thus, a processor that is powered off or is executing other software, but has the described software installed on a data store in operative connection therewith (such as on a hard drive or SSD) in a manner that is setup to be executed by the processor (when started by a user, hardware and/or other software), may also correspond to the described/claimed processor that is configured to carry out the particular processes and functions described/claimed herein.

In addition, it should be understood, that reference to “a processor” may include multiple physical processors or cores that are configures to carry out the functions described herein. Further, it should be appreciated that a data processing system may also be referred to as a controller that is operative to control at least one operation.

It is also important to note that while the disclosure includes a description in the context of a fully functional system and/or a series of acts, those skilled in the art will appreciate that at least portions of the mechanism of the present disclosure and/or described acts are capable of being distributed in the form of computer/processor executable instructions (e.g., software and/or firmware instructions) contained within a data store that corresponds to a non-transitory machine-usable, computer-usable, or computer-readable medium in any of a variety of forms. The computer/processor executable instructions may include a routine, a sub-routine, programs, applications, modules, libraries, and/or the like. Further, it should be appreciated that computer/processor executable instructions may correspond to and/or may be generated from source code, byte code, runtime code, machine code, assembly language, Java, JavaScript, Python, Julia, C, C#, C++ or any other form of code that can be programmed/configured to cause at least one processor to carry out the acts and features described herein. Still further, results of the described/claimed processes or functions may be stored in a computer-readable medium, displayed on a display device, and/or the like.

The disclosed remote support systems 200, 400 and remote support methods 500 provide reduction in need for specific technical training and skill in support of technical systems or products 250. Advanced troubleshooting through network accessible information, including AI-based troubleshooting, is possible because of disclosed communication methodology which shields systems or products 250 from the

Internet, e.g. secure communication link 410 between systems or products 250 and user interface device 210.

1. A system for remote technical support comprising:
a user interface device comprising a memory storing a computer program with executable instructions,
an identification tag of a technical system, and
a secure communication link interfacing with the user interface device and adapted to transmit data,
wherein the computer program comprises instructions
to read the identification tag,
to establish communication to the technical system via the secure communication link, and
to obtain technical data of the technical system via the secure communication link,
wherein obtained technical data comprise system log files and current status including I/O states of the technical system,
wherein, via the secure communication link, the obtained technical data are transmitted to the user interface device and are further processed by an application for remote technical support
and further comprising a wireless communication network interfacing with the user interface device and adapted to transmit data,
wherein instructions or information for providing the remote technical support are downloaded from a cloud-based application via the wireless communication network to the user interface device without transferring the obtained technical data to the cloud-based application.

2. (canceled)

3. The system of claim 1, wherein the application is configured to process the obtained technical data on the user interface device and to connect to a remote data reservoir, the application being in communication with the remote data reservoir for processing of the technical data.

4. The system of claim 1, wherein the secure communication link comprises a short range wireless network protocol.

5. The system of claim 1, wherein the identification tag comprises a network address of the technical system.

6. The system of claim 1, wherein the identification tag comprises a QR code or a barcode or other machine-readable label.

7. (canceled)

8. The system of claim 1, wherein the application is configured to suggest failure modes and associated solutions, provide maintenance manuals and/or videos, establish contact to technical support, and order parts for the technical system.

9. The system of claim 1, wherein the application comprises machine learning functionality, wherein a history of interaction with various technical data of multiple technical systems is used to provide specific actionable data to a user of the technical system.

10. The system of claim 1, wherein the user interface device is selected from the group consisting of a tablet, a smart phone, and a handheld computing device.

11. The system of claim 1, wherein the technical system comprises a mail or parcel processing system including an unloading apparatus and/or a diverter apparatus and/or singulator apparatus and/or a conveying apparatus.

12. A method for remote technical support comprising:
reading, by a user interface device, an identification tag of a technical system,
establishing communication by the user interface device to the technical system via a secure communication link,
obtaining technical data of the technical system via the secure communication link,
wherein obtained technical data comprise system log files and current status including I/O states of the technical system,
wherein, via the secure communication link, the obtained technical data are transmitted to the user interface device and are further processed by an application for remote technical support
wherein instructions or information for providing the remote technical support are downloaded from a cloud-based application via a wireless communication network to the user interface device without transferring the obtained technical data to the cloud-based application.

13. (canceled)

14. The method of claim 12, wherein the application is configured to process the obtained technical data on the user interface device and to connect to a remote data reservoir, the application being in communication with the remote data reservoir for processing of the technical data.

15. The method of claim 12, wherein the secure communication link comprises a short range wireless network protocol.

16. (canceled)

17. The method of claim 12, further comprising:
providing, by the application, suggested failure modes and associated solutions and/or maintenance manuals and/or videos.

18. The method of claim 12, further comprising:
establishing, by the application, contact to technical support.

19. The method of claim 12, further comprising:
ordering parts for the technical system via the application.

20. The method of claim 12, wherein the application comprises machine learning functionality, wherein a history of interaction with various technical data is used to provide specific actionable data to a user of the technical system.
